(19) United States
(12) Patent Application Publication
(10) Pub. No.: US 2006/0279575 A1
(43) Pub. Date: Dec. 14, 2006

(54) SYSTEMS AND METHODS FOR GENERATING 3D SIMULATIONS

(76) Inventors: Patrick Pannese, Lynnfield, MA (US); Sharon Satnick, Wakefiled, MA (US)

Correspondence Address: STRATEGIC PATENTS P.C.., C/O PORTFOLIOIP, P.O. BOX 52050, MINNEAPOLIS, MN, 55402, US

(21) Appl. No.: 11/427,723

(22) Filed: Jun. 29, 2006

Related U.S. Application Data
(63) Continuation of application No. 11/123,966, filed on May 6, 2005.

(51) Int. Cl. G06T 15/70

(52) U.S. Cl. 345/474

(57) ABSTRACT

An aspect of the present invention relates to methods and systems for creating real-time closed loop parametrically driven simulations for inverse kinematics defined objects using models created by a computer aided design application. In embodiments, custom design inverse kinematics devices are imported into the simulation application and users interactively modify parameters defining the inverse kinematics device.

### RELATED APPLICATIONS

This application is a continuation of commonly-owned U.S. application Ser. No. 11/123,966, filed on May 6, 2005, the entire contents of which are incorporated herein by reference. This application is also related to commonly-owned U.S. application Ser. No. 11/425,755, filed on Jun. 22, 2006, the entire contents of which are incorporated herein by reference.

### BACKGROUND

1. Field

This invention relates to methods and systems for creating real-time physical device simulations, more particularly, embodiments, of the present invention relate to real-time closed loop parametrically driven simulations for inverse kinematics defined objects using models created by a conventional computer aided design application.

2. Description of Related Art

A physical device (e.g. a robot arm) typically contains a plurality of links, arms, end effectors, belts, and lifters that move in a coordinate system from one point to another. An example of a physical device may be a robot that may be capable of simple pick and place or a more complicated device for assembly. Unlike other three-dimensional devices that may move with linear motions to various positions, physical devices may have several pivoted and connected extensions that each may be moved in a plurality of ways to arrive at the same final point. As a simple example, a robot with two arms may move an object three feet. Arm one may be moved one foot while the second arm may be moved two feet to arrive at the final point. But it can be seen that the two arms may have an almost infinite number of move combinations that add up to the three-foot move. The two arms may be of unequal lengths and therefore may each have different motion arcs. Inverse kinematics equations define the interaction of the various sub-parts of a physical device to provide an answer to which sub-part to move a distance to achieve a final position.

Devices such as robots are called inverse kinematics devices because they require inverse kinematics equations to define the motion possibilities of the various sub-parts of the devices. Specialized applications are required to simulate the motions of inverse kinematics devices defined by inverse kinematics equations based on pivot points and linear moves of the device.

Simulation applications exist that model and simulate three dimensional devices, including inverse kinematics devices. These applications allow the designing of the inverse kinematics devices with built-in computer aided design (CAD) applications or use standard libraries of available devices for simulations. Using custom-designed devices from a standard CAD application may typically require exporting to a particular format for import into the simulation application. Many industries custom design devices to fit in a particular situation in a facility or manufacturing line and wish to take advantage of simulations of the device. Often an industry standard device may not provide the reach, size, speed, or accuracy to meet the needs of a facility. Accordingly, a need exists for an application that imports custom inverse kinematics devices into a closed-loop parameter driven simulation application and provides a user with an interface to adjust not only the devices motions but design parameters interactively.

### SUMMARY

Provided herein are methods and systems for providing simulation of inverse kinematics devices based on three-dimensional objects created in a standard computer aided design (CAD) application. A three-dimensional object from the CAD application may be captured and exported to a standard file format. A motion profile data file may be created, and the motion profile data file may be transmitted to a client simulation application.

The first step in a method or system according to the principles of the present invention may be the development of a three-dimensional model by capturing a design from a three-dimensional CAD model. The three-dimensional model may be analyzed to identify one or more moving parts of the object and determining one or more inverse kinematics relationships for one or more moving sub-parts. Inverse kinematics are equations that describe the motion of objects that contain a plurality of sub-parts, such as arms or links to move an end effector in a device. The individual arms or links may be moved independently in a plurality of motions to move the end effector of a device to a position. Inverse kinematics equations may define the motion of each of the sub-parts in a coordinate system. The object may be exported to a file format capable of storing a characterization of the moving parts including the one or more inverse kinematics relationships.

The three-dimensional computer automated design model may be provided by an industry standard CAD application such as SolidWorks, ProE, AutoCad, or any other application capable of three-dimensional model development. The three-dimensional computer aided design model may be used to create a standard .X file format. The .X file format may be a textual file describing a three-dimensional object in hierarchical levels. In embodiments, the .X file may be created by export from a CAD application, by a digital content converter, or by a file export/translation tool. The .X file may be created for each three-dimensional object to be used in a simulation. Once the .X file is created, a mesh data extraction utility may be used that may remove unnecessary detail from the .X file.

The three-dimensional model may be identified for moving parts, such as where pivot locations may define the motion of the inverse kinematics object. The relationship between moving parts may be defined as inverse kinematics relationships. The motion of each sub-part of a device, such as the individual arms or links that may have been determined to have independent motion, may be defined. The .X file format may not be suited to contain pivot motion data, therefore at lease one .X file describing motion may be created for each object that requires part motion information.

Once the .X files have been created that may define part motion information, the .X file may be parsed to extract only the shell description for the object desired for a simulation. This information may be extracted using a custom parser application that may allow the user to extract only the information needed for the simulation.

The next step in the process may be to optimize the .X file model that may include one or more objects, each of the objects may include inverse kinematics motion. The optimized .X file model may be used to generate a template for a packet stream that is better suited to be transmitted over a network. The packet stream may have data to describe the inverse kinematics object motion and other characteristics of an object. The transmitted packet stream may be used to simulate the object at a client application that receives the description. A simulation may display motion of at least one object by transmitting a packet stream over the network to the client application.

Polygonal data may be extracted from an .X file that has been created from a three-dimensional model. A three-dimensional mesh may be created for the polygonal data creating a shell for the .X file model. The extracted polygonal data may maintain the resolution of the original three-dimensional design model. The .X file polygonal data may be optimized to provide improved performance in a client simulation application. A polygonal optimization may minimize the number of polygons in the mesh shell using polygon decimation. It can be understood that the fewer polygons that the client simulation application is required to display, the smoother and faster the display may refresh. In addition, attribute/index ordering may also be used to enhance the display rate of the client simulation application. The polygonal skin may be applied to the .X file manually or automatically by software. Once the polygonal skin is applied to the .X file, all other three-dimensional model information except polygonal skin may be discarded. The unneeded polygonal information may be discarded manually or automatically by software.

A packet description file may be created from the .X file model. The packet description file may be textual based and may use a simple name format for the description of the motion object. The packet description file may be created automatically or manually. The naming format of the packet description file may contain information for each sub-part of an object and the type of motion for that sub-part. The packet description file may describe sub-parts such as the arms, motors, or end effectors. The packet description file may be used to generate a packet stream that may be transmitted to a three-dimensional simulation client. The number of packet description files may be based on the number of inverse kinematics objects defined for the three-dimensional simulation client. A one to one relationship between the packet description file and the inverse kinematics objects may be maintained. A part motion or translation motion may be described as yaw, x, y, z or any other applicable coordinates.

Network packet data may be automatically generated for each inverse kinematics object and may provide data for all the parameters of the packet description file. The network packet may provide data for the parameters described in the packet description file such as yaw, x, y, z or any other applicable coordinates. A physics engine may create the data for the network packet. The physics engine may restrict motion to the capability of the inverse kinematics (“IK”) object device. The physics engine may receive input from input devices. The input device may be a mouse, a joystick, a keyboard, a touch pad, or any type of input device.

The network packet may provide motion data to the three-dimensional simulation client. The network packet data may be transferred using a standard protocol such as UDP/IP, TCP/IP, .NET remoting, or any other network protocol. The network packet data stream may be decoded using the packet description file.

A three-dimensional simulation client may display objects based on the received network packet data stream. The client may decode the network packet data stream according to the packet description file by applying the information of the packet description file to the network packet data stream. The three-dimensional simulation client may display the inverse kinematics object defined by the network packet data stream. A plurality of transferred network packets may describe each inverse kinematics object in the three-dimensional simulation client. Network packets may be continuously transferred over the network to define motion of the objects in the three-dimensional simulation client. There may be a network packet description file and associated packet stream for each inverse kinematics sub-part and including each motion by the inverse kinematics in the simulation.

A simulation graphical user interface displaying at least one object in motion may be provided for creating a complete simulation of inverse kinematics objects. Inverse kinematics objects may be added to the simulation by a drag and drop or dimensional placement method and may be placed anywhere in the simulation. Objects to be placed in the simulation may be selected from a list of objects based on previously received packet description files. Additional objects may be added to the simulation from a library of simulation compliant objects that may be described by packet description files. A user may be able to interactively adjust an object simulation parameter to revise the object motion within the simulation. This may be done to avoid a collision with another inverse kinematics object or a non-moving object such as a container, wall, ceiling, floor, facility structure, product, or any other non-moving object in the simulation. The parameters of the objects may be changed “on the fly” and the simulation may be rerun with the new revised parameters. Simulation object parameters may be adjusted for arm length, motor speed, encoder resolution, end effector types, acceleration, z speeds, scaling factors, or any other appropriate parameter for the object.

The object library may contain simulation compliant objects that may be representative of available inventory objects for a particular facility. The library objects may be of industry standard objects or previously designed and stored three-dimension models described by packet description files. A network packet stream transmitted over a network may describe the motion of a library simulation object within a three-dimensional simulation client.

The library objects may be added to a simulation that may contain other library objects or objects originated from a three-dimensional CAD application. The simulation objects in the three-dimensional simulation client may be drag and dropped into any location within the simulation.

The motion data from the network packet may be applied based on a real-time clock. The network packet may be updated with motion data from an input device such as a mouse, a joystick, a keyboard, touch pad, or any other input device. As the input device revises the motion data of an object, the network packets may be transmitted to the three-dimensional simulation client based on a real time clock that may have a resolution determined by the hardware and software capabilities of the computer environment. A Read Time Stamp Counter (RDTSC) or other defined method of clock timing may be used. The network packet stream may be transmitted to the three-dimensional simulation client using a standard communication protocol such as UDP/IP, TCP/IP, .NET remoting, or any other network protocol. The use of network packets may provide a common framework for single point of control for a simulation.

Using these techniques, a real-time stand-alone inverse kinematics solution may be created within the three-dimensional simulation client. The real-time solution may be a closed loop real-time parameter driven solution.

Once a simulation solution is created, it may be correlated to physical inventory for determination of availability of a device described by a simulation object. The correlation may match parameters to devices in physical inventory using automatic discovery matching for each inverse kinematics object in the solution to an actual device.

A simulation solution may model a physical system and may be used to provide teaching of the physical system to respond to an input with a predetermined output. The teaching may be applied to at least one physical device based on the computerized model of the physical system.

The simulation solution may provide a visualization of a facility before physical construction. The simulation solution may allow collision detection to be performed without potential damage to the physical devices. The final simulation solution information may be used to revise the three-dimensional computer aided automated design model to a final configuration. This process may be iterated, with new files created for a new simulation, until a simulation solution is created that meets all of the users requirements.

A file may be created for application on a physical device based on the teaching performed in the simulation solution. The files may be generated by the three-dimensional simulation client for any of the physical devices of a facility. The files created from the simulation solution may already have accounted for collision avoidance. System design considerations may be re-evaluated based on the file, exposing potential design implications such as collision or other mechanical consideration in a system test. Using the simulation solution for the creation of the physical device files may replace manual object teaching in the facility.

### BRIEF DESCRIPTION OF FIGURES

The invention may be understood by reference to the following figures.

FIG. 1 shows an embodiment of a typical robot.

FIG. 2 shows a high level flow chart of the .X file creation according to the principles of the present invention.

FIG. 3 shows a schematic of the .X file creation logic in more detail according to the principles of the present invention.

FIG. 4 shows a high level flow chart of the packet description file and network packet file creation and transmission according to the principles of the present invention.

FIG. 5 shows a schematic of the packet description file and network packet file transmission according to the principles of the present invention.

FIG. 6 is a high level schematic showing the process of creating the required files and transmitting the files to the client application according to the principles of the present invention.

FIG. 7 shows a high level flow chart describing the process of simulation optimization and file transfer to a device according to the principles of the present invention.

FIG. 8 shows a high level schematic of the architecture simulation application according to the principles of the present invention.

### DETAILED DESCRIPTION OF FIGURES

A physical inverse kinematics (IK) device (e.g. robotic device, robot, robot arm, articulating arm, multiple linkage device) may be any device that is capable of motion that can be described by an IK equation. IK equations are mathematical equations in a coordinate system that may describe the positioning of at least one movable component of a device. IK equations may be used to predict the placement of an end point of a device based on the motion of the movable components or predict the motion of the movable components based on the position of the end point. The typical physical IK device may have more than one movable component. For example, it can be understood that a physical IK device with two movable components may have an almost infinite number of individual motions for the two movable components to achieve the same resulting motion of the end point of the components. Physical IK devices with more than two movable components or unequal movable component lengths may further complicate the description of the positioning of the end point. Physical IK devices may range from simple single motion components to move material from one point to another to complicated multi-component devices that may hold and assemble product in an assembly line.

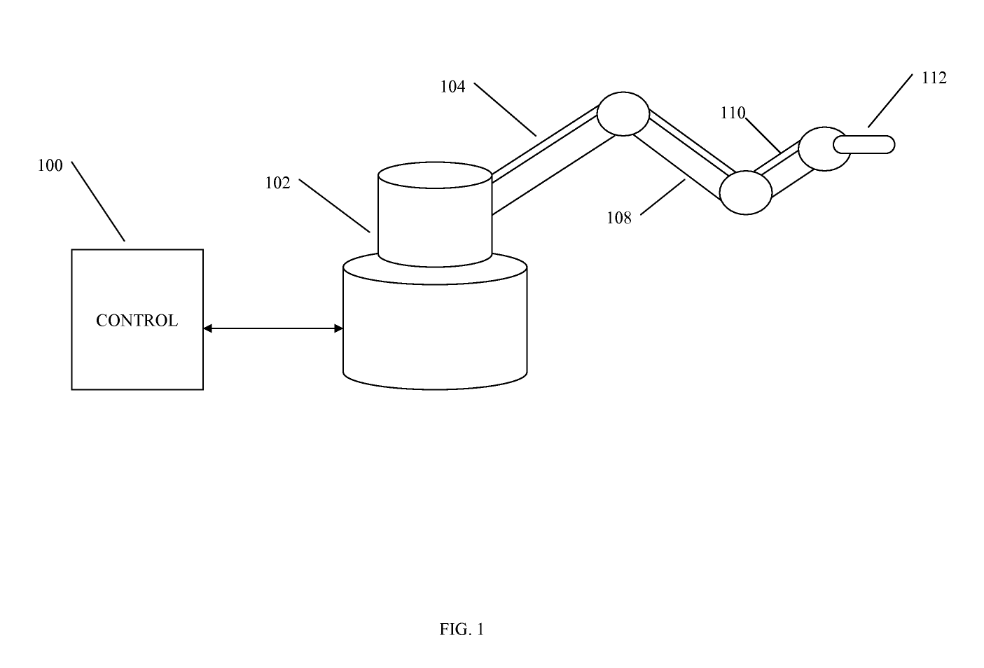

Referring to FIG. 1, a typical embodiment of a robot is shown. Robots may be used for various purposes, from working in harsh environments to simple picking and placing work. Robots often perform work that may be harmful to humans or to perform tedious tasks that may be better performed by a physical device. Because robots often perform tasks that humans may have performed, the three-dimensional motion paths often reflect the type of motion a person may have used. Often robots may be “taught” the correct movement paths by a user accessing a control 100 to command the robot to move in a certain path. The control 100 may record the robotic device taught paths that may be repeated as its task.

Often during the teaching of the robot, the user may be concerned with any possible collisions with fixed objects, the work piece, or other robotic devices. If there is a plurality of robots working in an area, their motions must be coordinated with each other to avoid collisions or interferences. A person responsible for the layout of a manufacturing facility may need to rearrange the layout during a facility setup to allow the robotic devices to perform their work properly.

In the typical robot of FIG. 1, a robot may be considered to be the entire group of controls 100, base 102, arms 104, 108, 110, and end effector 112. The control 100 may contain the electronics to drive the motors of the various arms 104, 108, 110 and may maintain the memory required to record path motions file. The control 100 may be connected to a base 102 that may be shaped to aid in the positioning of the arms 104, 108, 110 and the end effector 112. The base 102 may provide a location for various motors for the movement of the arms 104, 108, 110.

A robot may have a plurality of arms 104, 108, 110 to allow for proper positioning of the end effector 112 that may do the gripping or holding of a part or tool. It can be understood that an increased number of arms 104, 108, 110 may allow the robot to have more degrees of freedom in its motion. In an embodiment, a robot with just one arm 104 may be useful in moving an object from one location to another. The one arm 104 may also be used with an elevating motor to move the arm up or down.

With the addition of a second arm 108, the robot may now be able to reach farther and possibly around an object. The second arm 108 may allow the robot to not only to move an object from one station to another but also to pick up the object from one station and move it to another station that may be a different distance away.

The addition of a third arm 110 may allow the robot the ability to reach around or over objects. The combined arms 104, 108, 110 may allow the robot to reach up, over, and down the other side of an object. It can be seen that the addition of more arms may add more capability to the robot. In addition to arms a robot may also contain a vertical or horizontal motion.

At the end of the arms 104, 108, 110 there may be an end effector 112 that may be able to move or grab an object. It may be common for the end effector 112 to have a device capable of additional motion as in a human wrist, allowing for a final fine positioning of the end effector 112 to a work piece.

All of the arms 104, 108, 110 and end effector 112 may move independent of each other creating a complex motion description. Even with a teaching control there are many parts to move in a plurality of ways to get to the same point in space. The arms 104, 108, 110 may not be of equal lengths giving each arm 104, 108, 110 a unique swing radius. As compared to many other machines that may typically operate in 2-5 axis, a robot may move each individual arm independently to move an end effector to a final position. A complex description of arm motion results because there may be an infinite number of coordinated moves for the independent arms to arrive at a common location.

Inverse kinematics equations describe the motion of a multi-armed device in a coordinate system. A set of equations may be established that describe each sub-part of a robot based on a point of pivot. By applying values into the variables of the inverse kinematics equations, the independent arms 104, 108, 110 may be moved in increments that are advantageous to that arm. For this reason, a robot may be referred to as an inverse kinematics device.

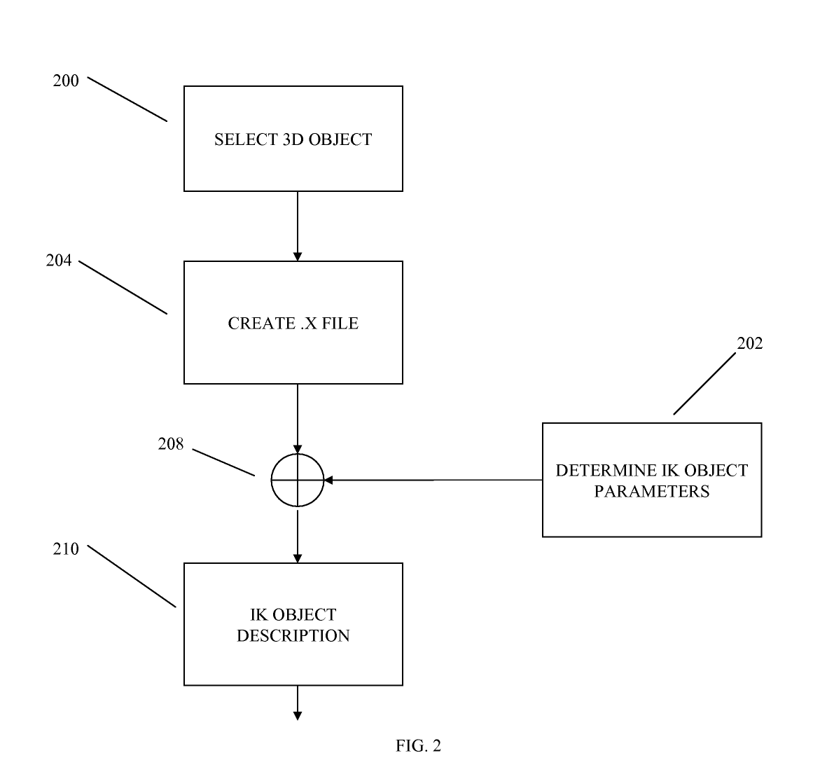

FIG. 2 illustrates a high level flow chart of a method of capturing three-dimensional objects from an existing three-dimensional computer aided design model according to the principles of the present invention. The three-dimensional design model may have been created in an industry standard computer aided design (CAD) application such as SolidWorks, ProE, AutoCad, or any other CAD application capable of three-dimensional model creation.

Three-dimensional objects of a CAD application may be selected 200 for inclusion in a simulation application that may represent inverse kinematics objects, non-moving solid objects, or constraints in a simulation. The CAD application, a digital content creation tool, or a file export tool may be used to export each three-dimensional object that is to be included in a simulation.

The three-dimensional objects may be exported 204 to a standard .X file. The .X file format may store descriptions of three-dimensional objects as a text file for use in simulation clients. The .X file format may have a parameter driven naming convention that may define every sub-part of a three-dimensional object. In an embodiment, each arm of a robotic device may be named and have parameters associated to the names that describe the robotic device arm to a client application. The parameters may include the type of motion a sub-part is capable of such as x, y, z, yaw, or other applicable motion parameter. The parameter information may be stored as a separate parameter file. The .X file format may not adequately describe the motion of an inverse kinematics object and therefore an inverse kinematics object may need to be captured from the three-dimensional design model in at least one additional position of motion. The two captured .X file and the associated parameter file may then be used to describe the pivot point for the motion.

The three-dimensional computer aided design model may be reviewed to determine if the object is an inverse kinematics described object 202. An inverse kinematics object may be any object that is capable of motion described by inverse kinematics equations. The inverse kinematics objects may be noted prior to an export to the simulation client.

Once the .X file has been created 204 from the CAD three-dimensional object and the IK object parameters 202 have been defined, they may be combined 208 to create an IK object description file 210. The combining 208 of the .X file and the IK object parameters may be done manually or automatically using software. The resulting IK object description file 210 may contain a naming convention for the individual motion components of the IK object and the parameters that will drive the motion of the IK object in a simulation client. For example, one element of the IK object description file 210 may be to describe a robotic arm. The element may be described as ‘Arm1’ with parameters of x, y, and, z. The parameters or x, y, and z may describe the motion axis that Arm1 may be capable of moving along. The IK object description file 210 may contain at least one element description. The entire IK object description file 210 may have a description and associated parameters of all the motion components of the IK object. The IK object description file may then be transmitted to a simulation client to be used for decoding actual parameter data during simulation.

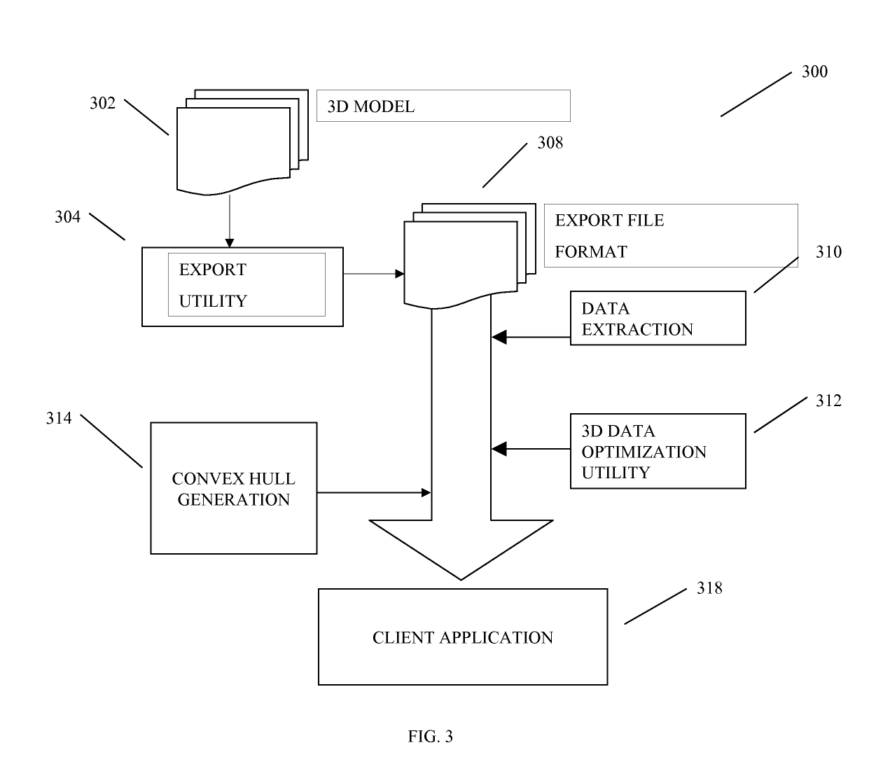

Referring to FIG. 3, a schematic of the exporting and file refinement of the three-dimensional model according to the principles of the present invention is shown 300. A three-dimensional model 302 may have been created from an industry standard CAD application that may fully describe an object for use in a simulation client. Each three-dimensional object to be used in a simulation may be exported using a CAD export utility, a digital content creation tool, or a file export tool 304. These tools may be used to create individual .X files 308 for each object to be used in a simulation application. The .X file format may not be typically capable of storing motion data of an object and therefore may need more information to describe motion. Three-dimensional objects capable of motion in a simulation application may require at least one additional parameter file that may describe the motion of the object. The two parameter files may then be used to define the pivot point of an object and therefore the motion of the object.

A data extraction utility 310 may be used to extract only the needed polygonal data representing the three-dimensional mesh of the object. The original resolution of the three-dimensional design model may be maintained during the extraction of the polygonal data. This may allow the simulation client to represent the plurality of objects in the same scale. In the development of an IK object device simulation it may be critical for all the objects to be correctly scaled to the actual IK device and to other IK object devices to be used in a simulation. The correct scaling of the IK object devices may allow a simulation result to be correlated to a physical construction of a facility.

The .X file may require polygon optimization 312 to minimize the number of polygons representing the three-dimensional mesh of the object. In simulation applications, the speed and motion fluidity may be a function of the number of polygons that need to be redrawn with each motion. The fewer the polygons that can be used to define the mesh of the object, the faster the simulation application may be able to redraw motion. The polygon optimization utility 312 may use polygon decimation to optimize the number of polygons in the object mesh. This process may combine the large number of small mesh polygons into fewer larger polygons that may still provide an accurate representation of the three-dimensional object. Attribute/index reordering may also be used to speed the simulator redraw and refresh process. Attribute/index reordering may optimize the object file for the order of the polygons for display by a simulation client. For example, a simulation client may render larger polygons first to present the more significant parts of the IK object and then fill in the smaller polygons or the smaller polygons may be rendered first followed by the larger polygons of the IK object. The attribute/index reordering may be a function of the simulation client used for rendering the IK object.

To further optimize the three-dimensional mesh of the .X file, a convex hull generation utility 314 may be used. Convex hull generation 314 is a process of creating a number of points defining the minimum shell of the polygonal shape. By running a convex hull generation on a previously polygon optimized file, a minimal three-dimensional shape may be created that accurately defines the mesh skin of a three-dimensional object. A second step in the convex hull generation 314 may be to remove all internal model detail of the object leaving only the external skin of the three-dimensional object. In an IK object simulation there may not be a need to have any additional object definition other then the external mesh of the IK object. Therefore all the internal object definition may be discarded from the final file definition. The convex hull generation may be completed manually or automatically using software.

Using this method, each object that is to be used in a simulation is extracted and optimized. Each object .X file may now be further transformed into file formats that are to be transmitted over a network to drive a simulation client.

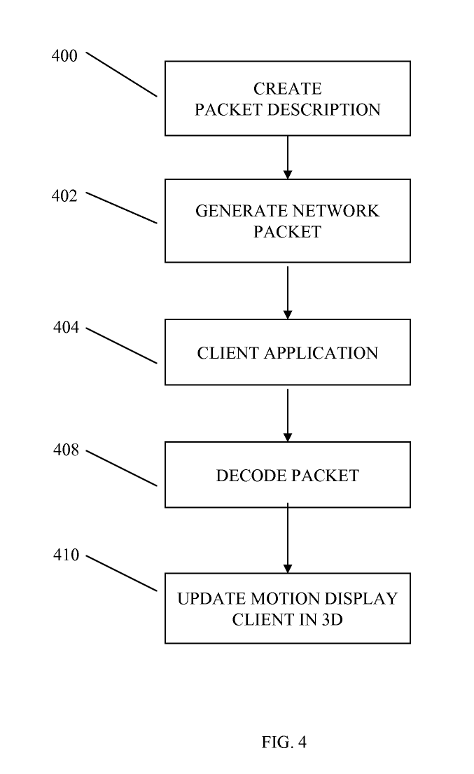

Referring to FIG. 4, a flow diagram of the creation of packet description files and network packets according to the principles of the present invention is shown. Once the .X files have been created for the objects in a simulation, file packet streams containing the object attributes may be transmitted over a network. A simulation client may be at a different location on a network and may receive the object information over a network for simulation.

For transmitting information to a simulation client, the .X file may be refined into packet descriptions. In an embodiment, a robotic object .X file may have attributes that may be exploited as a packet description 400 for each of the sub-parts such as links, arms, and end effectors. The packet description 400 may be created from the .X files by using the same naming format describing the object sub-parts. There may be a one to one relationship between the sub-parts of an object and the packet description 400 created, therefore there may be a packet description 400 for each object sub-part. The packet description 400 may be a parameter driven textual based file that describes the characteristics of the sub-part. The sub-part may be part of an inverse kinematics object involved in motion or translation motion. The packet description 400 may describe the motion capabilities of the sub-parts such as yaw, x, y, z, or other applicable coordinate parameter. The packet description 400 may be created automatically by software or manually by a user.

Once the packet description 400 have been created for the sub-parts of an object, the packet description 400 may be transmitted to a simulation client capable of interpreting the packet description 400. The simulation client may use the packet description 400 as a decoding file for motion data and other attributes that may be sent to the simulation client.

Network packet 402 may contain motion data for the object sub-parts using the same naming convention as the packet description 400. Network packet 402 may be automatically generated for each sub-part based on real time input from a user. Motion may be influenced by input devices such as a joystick, mouse, keyboard, touch pad, or any other input device. In an embodiment, the network packet file 402 may contain the motion data for each sub-part and may be decoded by the simulation client for motion parameters such as yaw, x, y, z, or any other applicable coordinate parameter.

The network packet data 402 may be transferred to the simulation client 404 using a standard communication protocol such as UDP/IP, TCP/IP, .NET remoting, or any other network protocol. A real time three-dimensional control and display simulation client 404 may receive the network packet data 402. The three-dimensional client 404 may decode the network packet data 402 according to the previously received packet description file 400. A physics engine may generate the network packet data 402. The physics engine may be influenced by the user input through the input devices. The physics engine may only generate network packet data that is within IK object motion capability. The physics engine may prevent the user from positioning an IK object device beyond the motion limits of the IK object device. In this manner, a simulation client may only display motion that is within the capabilities of the IK object device and allow proper correlation to the physical IK object device.

The network packet 402 may be decoded 408 by the three-dimensional client using the packet description 400. The decoded network packet 402 may describe the motion of each inverse kinematics object to the three-dimensional client 404. Network packets 402 may be continuously transferred over the network using a real time clock to define motion of each inverse kinematics object. For each network packet 402 transmitted to the simulation client 404, a sub-part motion may be defined and displayed.

The three-dimensional client 404 may interpret each object motion 410 using the network packet data 402 and packet description file 400. The interpreted motion of the object may be displayed on a graphic user interface (GUI).

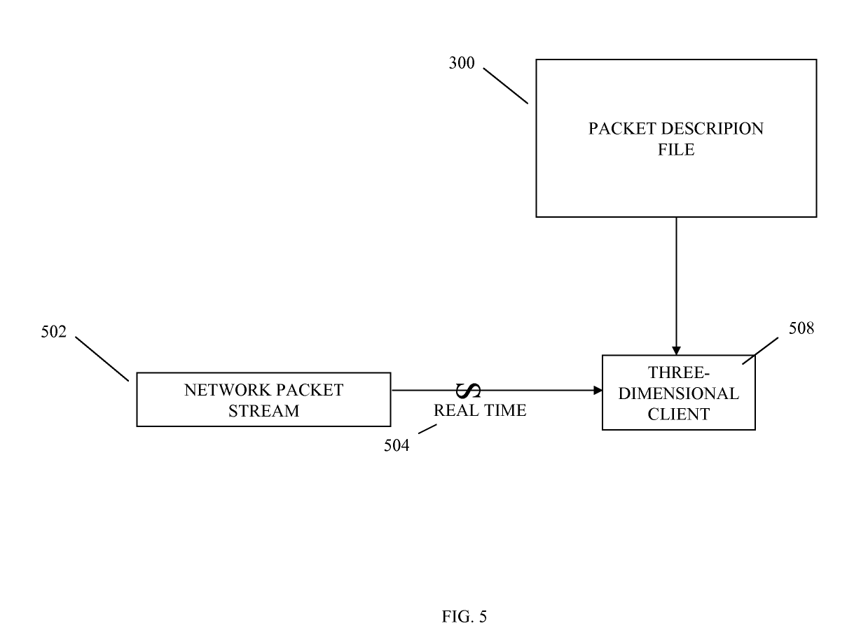

Referring to FIG. 5, a schematic of the combining of the packet description file 300 and network packet stream 502 to the three-dimensional client 508 according to the principles of the present invention is shown. The packet description file 300 may be created as described in FIG. 3, and may be transmitted to the three-dimensional client 508 using a standard network protocol. The three-dimensional client 508 may use the packet description file 300 to decode motion data transmitted over a network.

The network packet stream 502 may be automatically created as described in FIG. 4 and transmitted to the three-dimensional client 508. As the network packet stream 502 is created, it may be transmitted on a network using a real time clock. A Read Time Stamp Counter (RDTSC) or equivalent clock 504 may be used to time the transmission of the network packet stream 502 to the three-dimensional client 508. Using the real time clock 504, the timing resolution to the three-dimensional client 508 may be determined by the hardware and software capabilities of the computer environment.

The three-dimensional client 508 may combine the network packet stream502 containing sub-part motion data with the packet description file 300 containing the sub-part motion description. The packet description file 300 may define the display parameters of the sub-parts to the three-dimensional client 508. The three-dimensional client 508, to modify the display parameters of the sub-objects, may then apply the network packet stream502 data to the parameters of the packet description file 300. The resulting modified parameters may be displayed on the three-dimensional client 508 GUI as motion of the sub-parts. The combined simulated motion of the sub-parts may provide a simulation of the entire object.

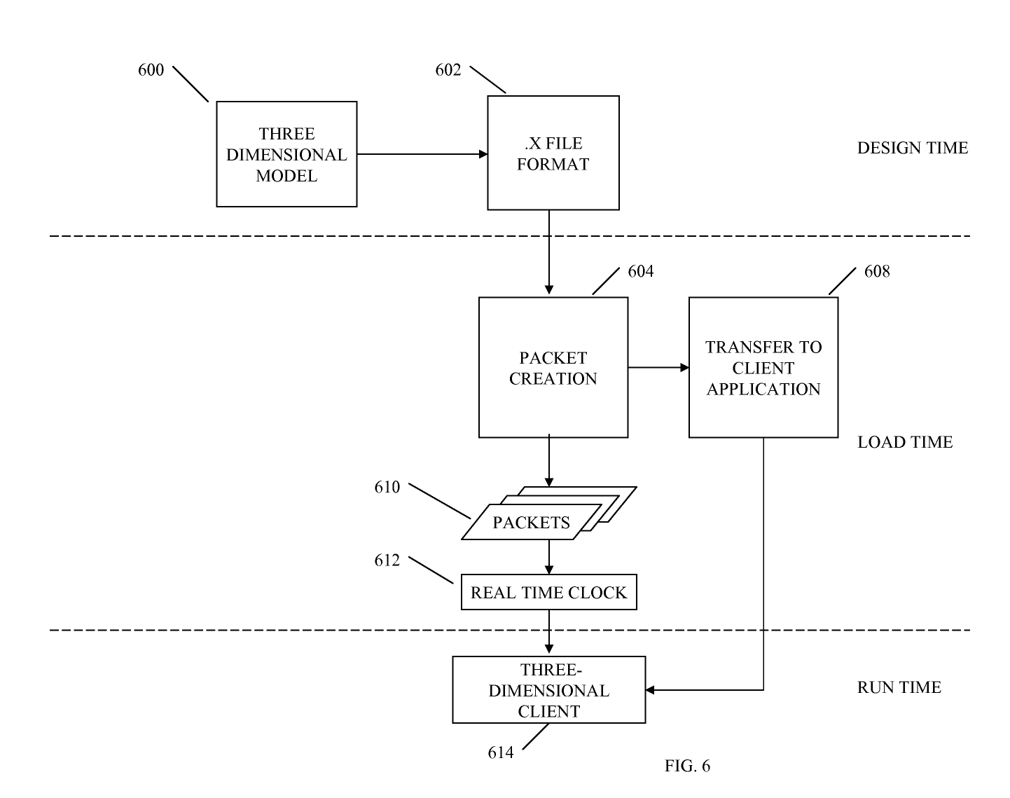

Referring to FIG. 6, an overall schematic for the method of transforming three-dimensional design models to a three-dimensional client as previously described is shown. A three-dimensional design model 600 may be created using an industry standard CAD application such as SolidWorks, ProE, AutoCAD, or any other CAD application capable of model creation.

An .X file format 602 may be created from the three-dimensional design model 600 by a CAD export utility, digital content creation tool, or other export tool. The .X file 602 may be optimized to simplify the mesh describing the model surface. The optimization may use methods such as polygon decimation to minimize the number of polygons describing the mesh of the object. Attribute/index ordering may also be used to enhance the display rate of the three-dimensional client 614. Additional polygonal optimization may be performed using convex hull generation that may further reduce the number of polygons defining the surface mesh of the object. After the final optimization is complete, the .X file model 602 then may have all detail that is not the surface mesh removed, leaving just an external surface of the object to be simulated.

With the .X file 602 optimized, a packet description file 604 may be created for each sub-part of an object that may display motion in a simulation. In an embodiment, a robotic object may consist of a plurality of sub-parts such as links, arms, and end effectors. The packet description file 604 may use the same naming convention as the .X file 602 for the definition of the object sub-parts. The packet description file 604 may be a parameter driven textual file describing every sub-part of the object and the type of motion the sub-object is capable such as yaw, x, y, z, or other dimensional parameter.

The packet description file 604 may be transmitted to a three-dimensional client application 608 that is capable of translating the packet description file 604 into a simulation display of the object and sub-objects. The packet description files 604 may be transmitted over a network using a standard network protocol such as UDP/IP, TCP/IP, .NET remoting, or any other network protocol.

Network packets 610 may be automatically created using the same naming convention as the packet description file 604. The network packets 610 may contain data describing the motion of each sub-part that has a defined packet description file 604. Network packets may be transmitted over a network using a standard network protocol such as UDP/IP, TCP/IP, .NET remoting, or any other network protocol. There may be a network packet 604 created for each sub-part and may be transmitted based on the RDTSC or equivalent clock 612.

Based on the clock 612, network packets may be transmitted to the three-dimensional client 614 for object simulation. The three-dimensional client 614 may use the previously received and stored packet description 604 to decode the network packets 610 that provide motion data for the sub-parts. The objects displayed using the three-dimensional client 614 GUI may be modified as defined by the network packets 610 data. The three-dimensional client 614 may use the network packet 610 data to modify the parameters of the packet description file 604 and therefore display motion as a simulation.

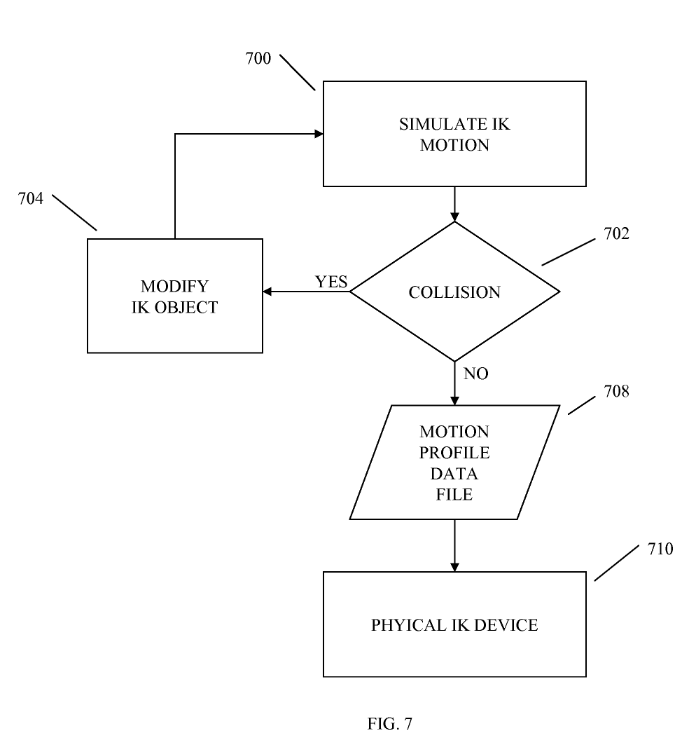

Referring to FIG. 7, a flow diagram describing the object simulation, modification of the simulation, and output of inverse kinematics files for physical devices according to the principles of the present invention is shown. A three-dimensional client 614 may be provided for the simulation of inverse kinematics objects 700. The three-dimensional client 614 may be able to access the packet description file 604 for the definition of simulation objects. The three-dimensional client 614 may also be able of use the network packets to modify the definition of the simulation object to provide simulated motion.

Objects may be placed on the three-dimensional client 614 GUI by selecting available objects that may be stored packet description 614 files. The objects may be able to be drag and dropped or dimensionally placed into any location on the three-dimensional client 614 GUI. A plurality of objects may be placed on the three-dimensional client 614 GUI for the display of a plurality of objects. In an embodiment, the plurality of objects may represent a manufacturing facility where robotic devices may be moving or providing work on material or product.

As part of the simulation, a library of simulation capable objects may be available for use in a simulation. These library objects may also be dragged and dropped or dimensionally placed into the simulation for interaction with other objects of the simulation. In an embodiment, the library of objects may represent industry standard devices or devices that are available within the facility being simulated.

As previously described in FIG. 6, network packets 610 may be transmitted to the three-dimensional client 614 and the objects of the simulation may display object motion. In an embodiment, the objects may be in motion simulating a process of a manufacturing facility. The three-dimensional client 614 may be able to detect collisions 702 between objects of the simulation. The three-dimensional client 614 may provide control over each object in the simulation to control the motion of an object. A joystick, mouse, keyboard, touchpad, or any other input device may be used to control the motion of the objects. The input devices may be used to modify the motion for each object in the simulation. The motion of the various objects in the simulation may be modified to prevent collisions or provide the desired path of a simulated object. In an embodiment, the modification of the object motions may be used to teach a simulated robot its required motions.

During the simulation 700 and collision 702 sequences it may be determined that an object must be modified 704 to prevent a collision or to better perform its task. The three-dimensional client 614 may allow on-the-fly modification of the parameters that define the objects 704. A user may be able to select an object in the simulation for modification and make revisions to a set of parameters. Parameters that may be modified may include arm length, motor speed, encoder resolution, end effector types, acceleration, z speeds, or any other scaling factors. With each modification 704 to the object parameters, the simulation 700 may be run again and the object motion 702 reviewed. This iteration method may be repeated until a simulation is provided that performs the needed tasks.

Once the simulation is performing the desired task, the simulation application may be able to create the motion profile data files 708 for the physical devices 710 represented in the simulation. A simulation motion profile data file 708 may define all of the motions required for the physical device 710 to perform a task. In an embodiment, the simulation application may be able to create the file in a format that is usable by a robotic controller 100. It may be possible to create a motion profile data file 708 for all of the physical devices 710 represented in the simulation. The motion profile data file 708 may be output on a media that is compatible to the robotic controller 100 such as tape, floppy disk, CD, DVD, memory stick, or other storage media used by a controller 100.

The creating of the motion files 708 from the simulation and applying the motion files 708 to the physical devices 710, the need to teach program a physical device 710 may be eliminated. Using this methodology, robotic lines may be installed and operational faster than if the robot had to be taught after installation. The simulation method may allow installations to be tested and files created prior to the robots being installed therefore possibly minimizing installation costs.

Once a simulation solution is created, it may be correlated to physical inventory for determination of availability of a device described by a simulation object. The correlation may match parameters to devices in physical inventory using automatic discovery, matching each inverse kinematics object in the solution to an actual device that may be available in inventory or may be purchased. The automatic discovery matching may use a database of existing and industry standard devices to determine if a device is available.

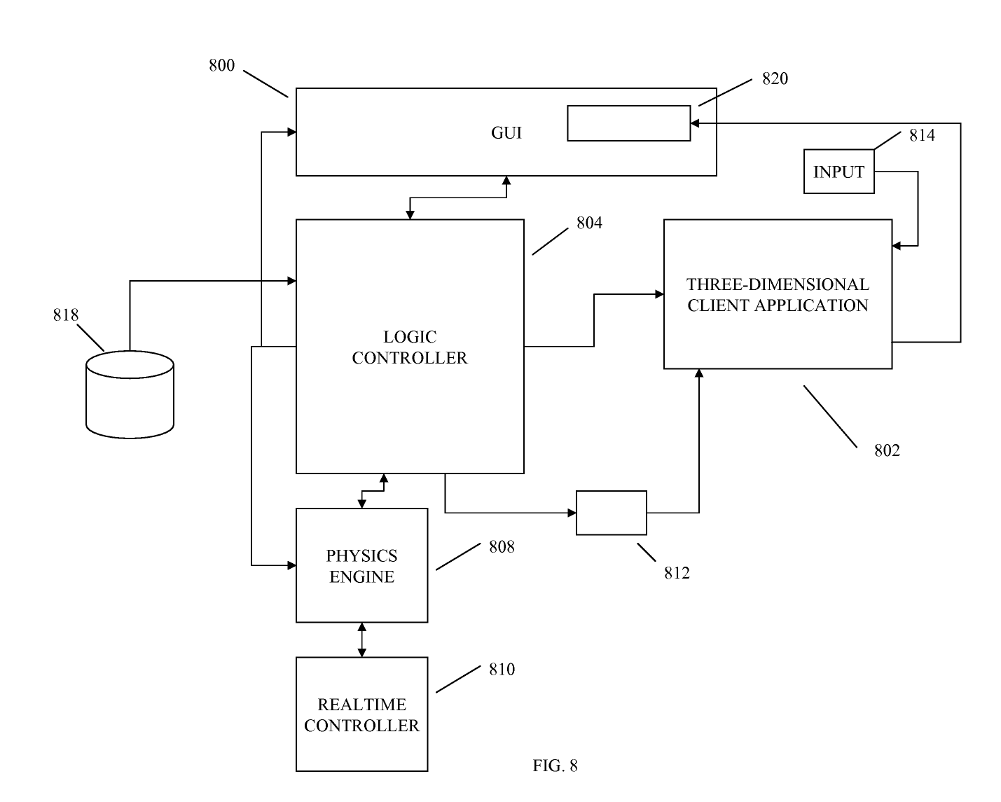

Referring to FIG. 8, a high level schematic of the simulation application architecture according to the principles of the present invention is shown. The architecture of the simulation application may consist of a GUI 800, three-dimensional client application 802, input device 814, logic controller 804, data storage 818, simulator 808, and real time controller 810.

The logic controller 804 may receive the network packet 610 and apply the motion data to the stored packet description file 604. The packet description file 604 may have been previously received and may be stored in storage 818. The storage 818 may also store at least one previously defined inverse kinematics object as a library. The library, as described earlier, may be used to place predefined objects into the simulation. Data may be stored in the storage device 818 as an XML file, tables, relational databases, text files, or any other file capable of storing data.

The logic controller 804 may interact with the physics engine 808 for inverse kinematics functions that define the motion of the simulated objects. The physics engine 808 may resolve the inverse kinematics equations for each inverse kinematics object sub-part for the logic controller 804. The physics engine 808 may receive timing for equation resolution from the real time controller 810, therefore controlling the timing of the equation solutions provided to the logic controller 804. The real time controller 810 may use a RDTSC or equivalent clock to provide timing resolution determined by the hardware and software capabilities of the computer environment to the physics engine 808. The logic controller 804 may provide simulation calculations for a plurality of objects being simulated simultaneously.

Once the logic controller 804 has interfaced with data storage 818, physics engine 808, and real time controller 810 to create a simulation instance for an object, the logic controller 810 may provided information to a three-dimensional client application 802. The logic controller may transmit data 812 to the three-dimensional client application 802 using a standard protocol such as UDP/IP, TCP/IP, .Net remoting, or any other protocol.

The three-dimensional client application 802 may be responsible for creating the three-dimensional representation of the motion data provided by the logic controller 804. The three-dimensional client application 802 may have a three-dimensional graphic engine for creating the three-dimensional motion data for the GUI 800. The three-dimensional client application 802 may also have a movement controller that may receive input from an input device 814 such as a joystick, mouse, keyboard, touchpad, or any other input device. A user may be able to control the motion of a simulated object by use of the input device 814, selecting the object to be controlled, and providing motion control.

The three-dimensional client application 802 graphics engine may transmit simulation graphic information to the GUI 800 three-dimensional graphics window 820. The three-dimensional graphics window 820 may provide a view of the complete simulation of a plurality of objects. The GUI 800 may provide interactive capabilities to the user in modifying objects and sub-parts in a simulation.

While the invention has been described in connection with certain preferred embodiments, it should be understood that other embodiments would be recognized by one of ordinary skill in the art, and are incorporated by reference herein.

All documents referenced herein are hereby incorporated by reference.

1-118. (canceled)

119. A method of simulation, comprising
providing a graphical user interface that displays a three-dimensional model including one or more objects, each of the one or more objects correlated to an existing physical inventory of system components;
receiving a network packet that characterizes a motion of at least one of the one or more objects;
simulating the motion using the received network packet to provide a simulation; and
displaying the simulation in the graphical user interface.

120. The method of claim 119, further comprising obtaining the motion from real time feedback.

121. (canceled)

122. The method of claim 121, further comprising controlling the motion with an input device.

123. The method of claim 122, wherein the input device includes one or more of a mouse, a joystick, a keyboard, and a touch pad.

124-127. (canceled)

128. The method of claim 120, wherein a time resolution is determined by the hardware and software capabilities of the computer environment.

129. The method of claim 128, wherein Read Time Stamp Counter (RDTSC) is used for a clock timing of the simulation.

130-131. (canceled)

132. The method of claim 119 further comprising transmitting the network packet using a communication protocol including one or more of TCP/IP and .NET remote.

133-136. (canceled)

137. The method of claim 119 further comprising adding a three-dimensional compliant object to the simulation using a drag and drop tool of the graphical user interface.

138. The method of claim 119 further comprising dimensionally placing a three-dimensional compliant object in the simulation.

139. The method of claim 138 further comprising defining the three-dimensional compliant object with a network description file.

140. (canceled)

141. The method of claim 119 further comprising creating a real-time stand alone inverse kinematics solution for the simulation.

142. The method of claim 141, wherein the real-time solution is a closed loop solution.

143. The method of claim 141, wherein the real-time solution is a parameter driven solution.

144. The method of claim 143, further comprising providing one or more parameters for the parameter driven solution in a packet description file.

145. The method of claim 143 further comprising modifying one or more parameters of the parameter driven solution with a user input.

146. The method of claim 143, wherein one or more parameters of the parameter of the parameter drive solution define at least one inverse kinematics motion in the simulation.

147. The method of claim 141 further comprising displaying the solution in real time.

148. The method of claim 119 further comprising deriving the three-dimensional model from a physical system.

149-150. (canceled)

151. The method of claim 148 further comprising automatically discovering one or more items of the physical system and correlating each of the one or more items to an item in the existing physical inventory of system components.

152-344. (canceled)

345. A computer program product embodied in a computer-readable medium that, when executing on one or more computers performs the steps of:
providing a graphical user interface that displays a three-dimensional model including one or more objects, each of the one or more objects correlated to an existing physical inventory of system components;
receiving a network packet that characterizes a motion of at least one of the one or more objects;
simulating the motion using the received network packet to provide a simulation; and
displaying the simulation in the graphical user interface.
